(19) United States
(12) Patent Application Publication
(10) Pub. No.: US 2024/0370008 A1
(43) Pub. Date: Nov. 7, 2024

(54) METHOD FOR IDENTIFIYING A SOURCE OF FAULT IN AN INTRALOGISTICS SYSTEM WITH THE AID OF A GRAPH MODEL

(71) Applicant: TGW Logistics Group GmbH, Marchtrenk (AT)

(72) Inventor: Thomas MAHRINGER, Pucking (AT)

(73) Assignee: TGW Logistics Group GmbH, Marchtrenk (AT)

(21) Appl. No.: 18/573,313

(22) PCT Filed: Jun. 24, 2022
(86) PCT No.: PCT/EP2022/067308

§ 371 Date: Dec. 21, 2023

(30) Foreign Application Priority Data
Jun. 25, 2021 (EP) 21181705.1

(51) Int. Cl. G05B 23/02

(52) U.S. Cl. CPC G05B 23/0275

(57) ABSTRACT

A method determines a cause of fault in an intralogistics system, wherein functional cause-effect relations between components are recognized from signal sequences of components of the system during anomaly situations and mapped in a graph model. Based on this graph model, one or multiple probable causes of a current anomaly of the intralogistics system are computed. It can be provided that, for creating the graph model, already known fault patterns are additionally taken into account and/or a manual input of causes of fault for an anomaly is done via an operator terminal.

### FIELD OF THE INVENTION

The invention relates to logistics systems. In particular, the invention relates to a computer-implemented method for determining a cause of fault in an intralogistics system, in particular in a picking system, on the basis of a graph model of the intralogistics system. Further, the invention relates to a computer program referring to the method, a storage medium, as well as an intralogistics system configured correspondingly and having a plurality of components, wherein the components comprise a component for storing articles, a component for processing orders and a component for transporting articles between the component for storing articles and the component for processing orders.

### BACKGROUND OF THE INVENTION

Modern intralogistics systems, such as, for example, distribution centers of commercial organizations, are highly complex plants with thousands, or even tens of thousands, of individual components, which interact technically with one another. Such components may be, for example, conveyor belts, sorters, intelligent rack systems, storage systems or other mechanical or electromechanical modules. Further, intelligent control systems for said components, as well as warehouse control systems (WCS), warehouse management systems (WMS) and material flow controls are provided in order to control the complex procedures and functions. These control systems receive data from said systems and also from data sources such as RFID scanners, barcode scanners, temperature sensors, motion sensors and similar sources that are implemented in an intralogistics system.

Against the background of increasing requirements for availability and performance, avoiding fault conditions or disruptions is an essential aspect of planning and operating an intralogistics system. If a fault nevertheless occurs in the intralogistics system, a rapid determination of the cause of fault and a prompt elimination of these causes can avoid lengthy downtimes and delays. Known systems often map the intralogistics systems in a static model of the intralogistics system. This may be, for example, a construction plan of the intralogistics system or a parts list of the individual components with their respective properties. Deposited in this may be, for example, information on which components are mechanically or electrically interconnected and how a spatial configuration is designed. Understanding effects, in particular during fault conditions, can support a search for the causes of fault.

Due to the enormous complexity of present-day intralogistics systems, determining a cause of fault on the basis of information contained in the construction plan or of parts lists is not promising. Because of the complex dependencies and interactions of the large number of components and configurations, many functional and causal interactions are neither known nor documented or modeled. In practice, an analysis of the cause of fault is therefore often done on the basis of the experience of the operating personnel. For example, if the performance of a picking robot drops, an operator may, from experience, search for a causal fault in a defective light barrier.

### DISCLOSURE OF THE INVENTION

It can be regarded as an object of the invention to provide an improved method for determining a cause of fault. This object is achieved by means of the independent claims. In particular, it is to be achieved that the determination of a cause of fault is not carried out exclusively on the basis of the experience of an operator, but that a scalable and effective alternative technical solution is provided. As a result, an availability and a productivity of an intralogistics system can advantageously be improved.

This is based on the following considerations: In an intralogistics system, there are multiple complex cause-effect relations between individual components. As a rule, these are multi-dimensional and complex. Often, technical cause-effect relations only occur in specific configurations of the intralogistics system and are often not known, or cannot be described, during the planning of intralogistics systems. As a consequence, the means currently available are insufficient to fully model such an intralogistics system from the initially available pieces of information, so that such a model cannot be used for a reliable search for faults.

Therefore, an improved method for determining a cause of fault in an intralogistics system and/or a picking system is proposed. An initial idea is to select a productive live system of such an intralogistics system as a starting point and determine the actual cause-effect relations from the actual operation. In a first step, a plurality of reference anomaly signal sequences are provisioned here relative to respectively associated normal operation signal sequences from signal sequences of a plurality of components of the intralogistics system. Here, signal sequences describe properties, parameters and/or pieces of condition information of a respective component of the intralogistics system. Such signal sequences can initially be understood to be general pieces of information that are suitable to describe components of an intralogistics system from a technical perspective. These may be, for example, electric measurement values, sensor data, optical properties, data of any kind, mechanical properties such as dimensions, material properties, physical quantities such as weight, density, velocity, temperature, chemical or biological properties and other descriptive quantities.

Components of the intralogistics system may comprise:
components for transporting articles, in particular a storage and retrieval system comprising storage and retrieval units, for example single-level storage and retrieval units (shuttles) and/or multi-level storage and retrieval units (stacker cranes), and/or a conveying system for transporting articles, such as, for example, a stationary conveying system, in particular an overhead conveying system and/or a ground-based conveying system, and/or a mobile conveying system, in particular autonomously displaceable transport vehicles, e.g. automated guided vehicles (AGVs) and/or autonomous mobile robots (AMRs),
components for sorting articles, such as, for example, sorting devices and suchlike,
components for processing orders, in particular automatic and/or manual workstations, for example picking stations, packing stations, picking robots and suchlike,
components for handling articles, for example palletizers, depalletizers, gripping robots and suchlike,
components for storing articles, in particular storage locations for storing articles, which are provisioned, for example, by means of mobile storage racks, stationary storage racks and/or suchlike,
components for supporting articles, in particular loading aids, for example trays, containers, boxes, hanging bags for the suspended transport of articles and suchlike and/or
components for processing data, for example software components, control devices, in particular warehouse management system (WMS), warehouse control system (WCS), and suchlike.

Here, a signal sequence can have a temporal factor, i.e. for example a curve over time or a sequence of measurement values, a sequence of data or pieces of information. A signal sequence can also comprise a combination of signal sequences of different components. Such a signal sequence can be generated during operation of an intralogistics system and be provided with time stamps in order to enable a comparability of system conditions at the same point in time. Properties of a component may be, for example, static quantities such as, for example, measures, weight, material, friction, power, energy consumption, temperature, as well as direct, derived and/or computed process properties such as, for example, a flow of articles, an article transport rate, a picking performance, an order fulfillment rate or suchlike.

Parameters of a component can be understood to mean, for example, configurable or changeable quantities, which are configured, for example, via a control software. Pieces of condition information may comprise, for example, pieces of sensor information at a specific point in time and describe electric, mechanical or other conditions. Conditions of a component may also be definable quantities, which result, for example, from the combination of different measurement values, pieces of sensor information, properties or parameters.

To detect the signal sequences, the intralogistics system can have a plurality of sensors, which detect properties of the components. The sensors can be arranged so as to be stationary in the intralogistics system or be inserted into the intralogistics system in a mobile manner, for example by means of drones or autonomously displaceable carrier vehicles.

One example of such a sensor may be, for example, a temperature sensor, in particular an infrared camera. The intralogistics system may have, for example, a plurality of infrared cameras, which record, continuously or in predetermined intervals, temperature values of components of the intralogistics system. To this end, each of the infrared cameras can acquire a plurality of images, in particular of a component assigned to the respective infrared camera. It can be provided that the images detected by the infrared cameras are used by an evaluation unit to create a (multi-dimensional) temperature matrix, wherein there are temperature values of each matrix dot for different points in time. These temperature values can be used to determine, for example, a signal sequence corresponding to the respective component.

A normal operation signal sequence describes a condition of at least part of an intralogistics system in a regular fault-free operating mode. In other words, the normal operation is to describe the condition of an intralogistics system that achieves a provided productivity or a provided throughput without a malfunction of a component concerned. An anomaly, in this context, is to be understood to mean a deviation from the normal operation and/or a fault condition of the intralogistics system or of a part and/or of a component of the intralogistics system. This means that an anomaly signal sequence can be understood to mean a signal sequence that occurs in case of a fault or failure of components and whose pattern differs from the normal operation signal sequence. This means that, if a fault occurs in an intralogistics system, the disrupted procedures result in modified signal sequence patterns, which occur on sensors, for example due to fault-related changes in measurement values.

The term “reference anomaly signal sequences” is to describe a suitability of these anomaly signal sequences for recognizing or referencing an anomaly signal sequence against the background of a given normal operation signal sequence. In other words, reference anomaly signal sequences can be stored and/or additionally verified in a database in large numbers and over a long period of time in order to then be used as a reference for recognizing anomalies. In accordance with one example, reference anomaly signal sequences are verified and/or historic anomaly signal sequences. In accordance with another example, the reference anomaly signal sequences are generated from signal sequences of other intralogistics systems. The reference anomaly signal sequences can therefore comprise known anomaly signal sequences from an intralogistics system and/or at least one other intralogistics system.

On the basis of the plurality of the provisioned reference anomaly signal sequences, a graph model is computed in a next step. This graph model describes a technical interaction of the components of the intralogistics system with the help of the properties, parameters and/or pieces of condition information. These interactive relationships can be described, for example, via nodes and edges of the graph model. The underlying idea can be seen in that a fault case of the system is utilized as a manifestation or visualization of given interactions and functional relations.

In other words, use is to be made of the effect that, in case of a malfunction of one or multiple components, the consequences manifest themselves as changed sensor values or pieces of condition information and the interactions thus become detectable and/or describable. Building on this basic idea, a technical cause-effect relation in a plurality of such anomaly states is then to be determined with the help of machine analysis methods. The term compute is to describe, in this context, all possibilities and ways for logically or analytically generating a graph model of an intralogistics system with technical means. Examples of this may be statistical computations or also sequences of logical computer operations.

Due to their network-like, multi-dimensional structure, graph models are suited for modeling highly complex cause-effect relations such as, for example, in intralogistics systems. Computing a graph model may comprise, for example, an analytical, processor-supported derivation and storage. In accordance with one example, the computing may comprise a logical derivation and/or generation of an interaction function between at least two components of an intralogistics system. Here, an interaction function can describe a logically or mathematically describable cause-effect relation between two technical components of an intralogistics system. In this context, the term graph model is to describe the general modeling approach, which may comprise a plurality of specific technical implementations, for example in different database structures, or also training an artificial neural network.

In a subsequent step, operative anomaly signal sequences are provisioned relative to an associated normal operation signal sequence from signal sequences of a plurality of components of the intralogistics system. An operative anomaly signal sequence can be understood to mean, for example, a signal sequence from a productive operative intralogistics system at a current point in time. In other words, it may be a currently detected fault condition of the intralogistics system with the associated signal sequences, which were generated over the period of time concerned, for example by detecting a plurality of pieces of sensor information. The term operative anomaly signal sequence is to illustrate that this signal sequence describes, on the one hand, an operative or current fault condition or anomaly. In accordance with one example, the operative anomaly signal sequence represents a current fault condition of the intralogistics system, without yet specifying a causal fault.

In the context of the goal of the method, a piece of operative anomaly cause information relating to this operative anomaly signal sequence, i.e. a causal cause of fault, is then computed on the basis of the graph model computed in the preceding step. In other words, the computed functional cause-effect relations in the intralogistics system that are stored and deposited in the graph model are then used to determine a causal source of fault relating to a specific anomaly signal sequence. An advantage of this method lies in a considerably more effective search for faults and elimination of faults, as an intralogistics-system-specific graph model can map the cause-effect relations in part or in full and even multi-stage or network-like cause-effect relations can be machine mapped and processed.

In one embodiment of the method, a piece of reference anomaly cause information in relation to the reference anomaly signal sequences is additionally provided. An additional computation of the graph model is done on the basis of this piece of reference anomaly cause information. In other words, the graph model is computed not only on the basis of the reference anomaly signal sequences but additionally also on the basis of the assigned pieces of causal fault information. The term piece of reference anomaly cause information is to indicate one or multiple sources of fault. In accordance with one example, these may be causal sources of fault, a plurality of causal sources of fault or also sources of consequential fault. This extension helps improve a quality of the modeling and therefore a quality and speed of the determination of the causes of fault.

In one embodiment of the method, the piece of reference anomaly cause information is provisioned via a human machine interface. Such an interface may be, for example, an input/output device of an operator, whereby a selection or input by an operator is enabled. In this manner, experience-based knowledge of a human operator can advantageously inform the graph model.

In one embodiment of the method, the computing of the graph model is done with the help of methods of graph analysis, machine learning, data mining, queuing theory and/or knowledge discovery in databases (KDD). In other words, the computing is done, for example, with graph algorithms, which support generating and storing an intralogistics-system-specific graph model. In accordance with one example, a graph model has a plurality of edges and nodes. In accordance with another example, edges of the graph model have a weighting. In accordance with one embodiment, the graph analysis comprises a connectivity analysis, affiliation analysis and/or path analysis in the step of computing the graph model. These methods of analysis can advantageously recognize and store interactive relationships between components of an intralogistics system.

In one embodiment of the invention, the provisioning of the reference anomaly signal sequence or of the operative anomaly signal sequence comprises recognizing a reference anomaly signal sequence or the operative anomaly signal sequence from a signal sequence by AI-based pattern recognition. In other words, this embodiment refers to the question of which technical means can be used to recognize an anomaly in the system in the first place. It is proposed in this context to train, in particular, an artificial neural network, for example with normal operation signal sequences, in order to recognize, on that basis, deviating patterns, i.e. anomaly signal sequences. In accordance with one example, an artificial neural network is trained with validated reference anomaly signal sequences in order to advantageously achieve an increase in the quality of the recognition.

In one embodiment, the provisioning of the piece of reference anomaly cause information is done by an artificial neural network which has been trained with validated combinations of anomaly signal sequences and associated pieces of anomaly cause information. In other words, the underlying idea is here that not an operator inputs the cause of fault manually, but known and validated combinations of typical anomaly signal sequences with the associated validated causes of fault, i.e. pieces of anomaly cause information, are used. This piece of anomaly cause information determined by an AI system then enters into the computation of the graph model as additional information. In accordance with one example, the provisioning of the piece of reference anomaly cause information comprises determining and/or correcting faulty assignments of pieces of reference anomaly cause information in relation to reference anomaly signal sequences.

In one embodiment, the provisioning of the piece of reference anomaly cause information is done by querying a database with validated combinations of reference anomaly signal sequences and associated pieces of reference anomaly cause information. This may mean that pre-checked and verified combinations of reference anomaly signal sequences and the associated causes of fault, i.e. the pieces of reference anomaly cause information, can be prepared, stored and/or intralogistics systems can be made available for reliably recognizing faults at different sites. The larger the number of verified datasets, the higher a precision of the recognition and tracing of causes of fault.

In one embodiment, the step of provisioning the piece of reference anomaly cause information in relation to the reference anomaly signal sequence and/or the step of provisioning the piece of operative anomaly cause information in relation to the operative anomaly signal sequences comprises the step of computing a probability of the occurrence of a respective anomaly cause. This may mean, for example, that a fault incident, i.e. an anomaly signal sequence, may have multiple causal sources of fault. For example, a specific runtime error can have different causes statistically over a plurality of intralogistics systems and a long period of time. For example, causes may be, here, defective adhesive strips in 70% of cases, defective films in 20% of cases, contaminations in 5% of cases and other causes in another 5% of cases. This may advantageously allow multiple causes of fault to be included, together with a corresponding weighting, in a modeling of the overall system.

In accordance with one embodiment, the graph model can be stored as an adjacency matrix, adjacency list or incidence matrix of a graph data structure. From a technical point of view, it is necessary to enable the cause-effect relations to be mapped in a computer system. To this end, it is proposed to design the intralogistics system such that it can be stored as a projection in a matrix and/or adjacency list using computing technology. In another embodiment, a configuration of the intralogistics system is provisioned, and the computing of the graph model is executed additionally on the basis of the configuration of the intralogistics system. A configuration of the intralogistics system can be understood to mean, for example, any and all information and documentation in relation to product life cycle management. In particular during the planning and configuration of an intralogistics system, extensive documentation, parts lists, construction plans and similar pieces of information are generated, which can be used as input quantities when computing the graph model. At the point in time when an intralogistics system is designed, known dependencies and interactive relationships, for example, can already be deposited in the model in the form of weighted edges and nodes.

In one embodiment, the method further comprises a step of generating optimized pieces of configuration information of the intralogistics system and/or its components on the basis of the computed graph model of the intralogistics system. The underlying idea is that, by computing a graph model, i.e. a digital image of technical, functional interactive relationships between the components of an intralogistics system, insight on probabilities and causes of fault can be gathered. This insight can be used to make intralogistics systems more robust and less susceptible to faults. This information can be used when designing and planning such intralogistics systems, for example. In accordance with one embodiment, the generation of optimized pieces of configuration information of the intralogistics system is done such that a probability of an occurrence of operative anomaly signal sequences is minimized. This may mean that the occurrence of fault incidents and anomalies is reduced already due to an optimized structure and optimized configuration. An advantage of this may be more robust intralogistics systems with a reduced susceptibility to faults.

In one embodiment, the provisioning of the reference anomaly signal sequences is done such that the multiple reference anomaly signal sequences at least partially relate to the same period of time. This means that anomaly signal sequences, for example also operative anomaly signal sequences, which relate to the same period of time, for example from different regions of an intralogistics system, in particular from different components, or also across the intralogistics-system, are evaluated at different sites. In other words, multiple signal flows are taken into account in parallel. In this way, larger relational contexts can be recognized and used for recognizing faults.

It should be noted that some of the possible features and advantages of the invention are described herein in relation to different embodiments. A skilled person will see that the features can be combined, adapted or replaced in a suitable manner in order to arrive at other embodiments of the invention.

Below, embodiments of the invention are described with reference to the enclosed drawings, wherein neither the drawings nor the description are to be construed as limiting the invention.

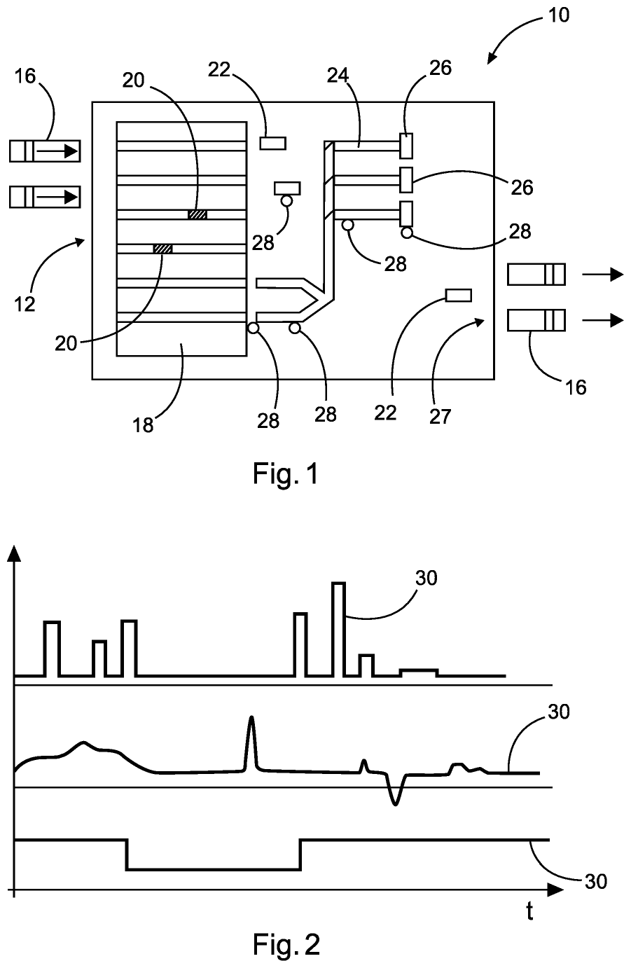

FIG. 1 shows a simplified intralogistics system with selected components in accordance with the prior art;

FIG. 2 shows examples of different kinds of signal sequences of components of an intralogistics system;

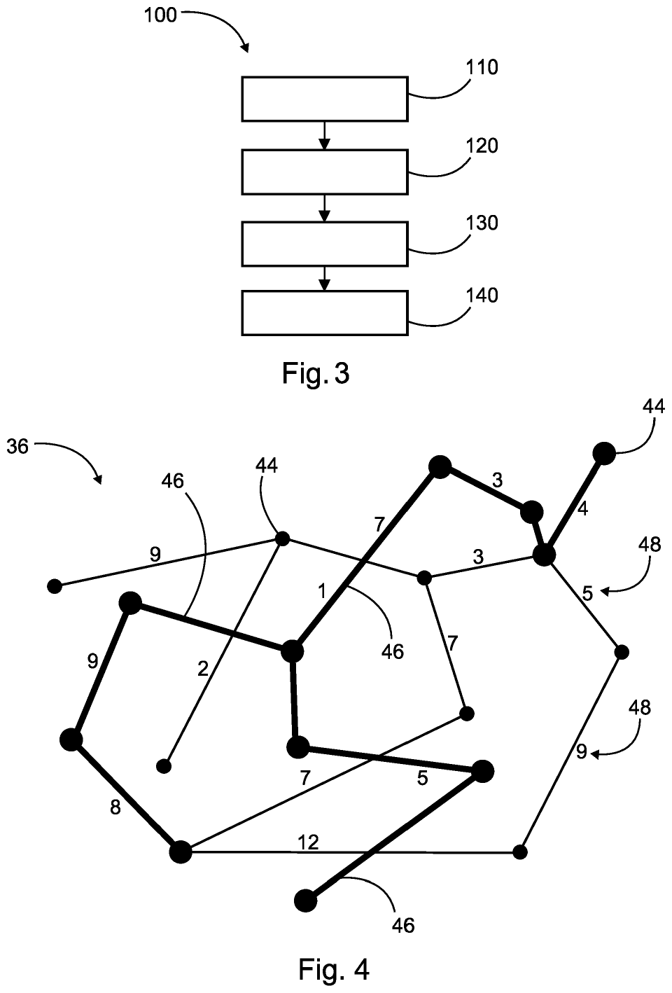

FIG. 3 shows a method in accordance with the invention for determining a cause of fault in an intralogistics system;

FIG. 4 shows an example of a graph model in accordance with the prior art;

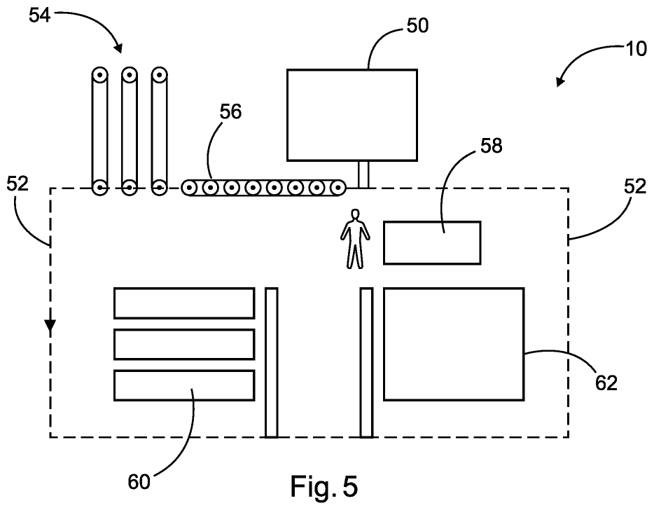

FIG. 5 shows a detail of an intralogistics system with a palletizer, a sequencer, a transport path and other components;

FIG. 6 shows a fault analysis unit in accordance with the invention with a graph database and anomaly recognition unit;

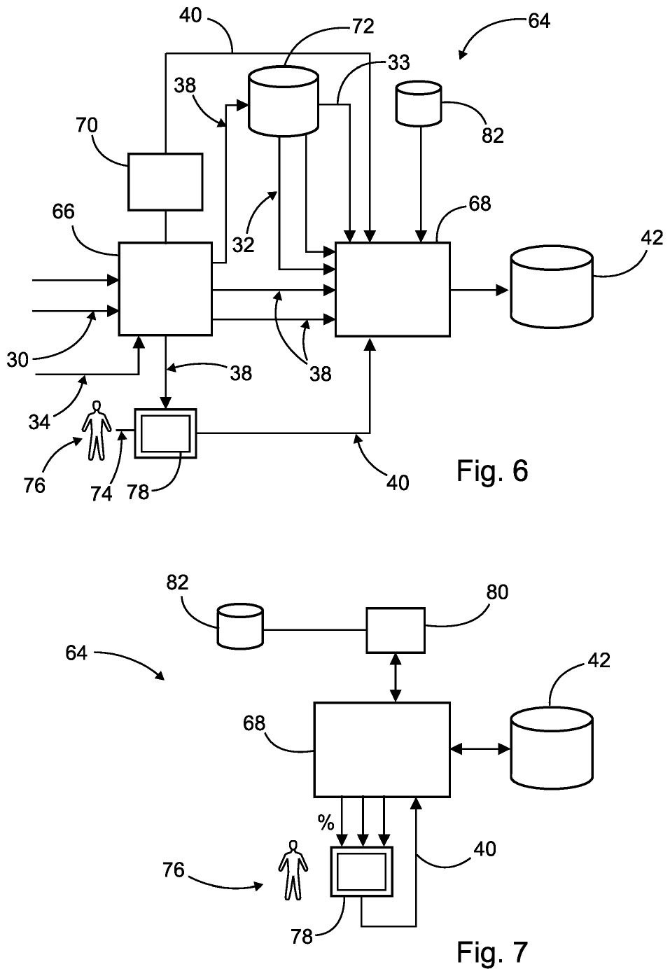

FIG. 7 shows a fault analysis unit in accordance with the invention with a human-machine interface for tagging probable causes of fault;

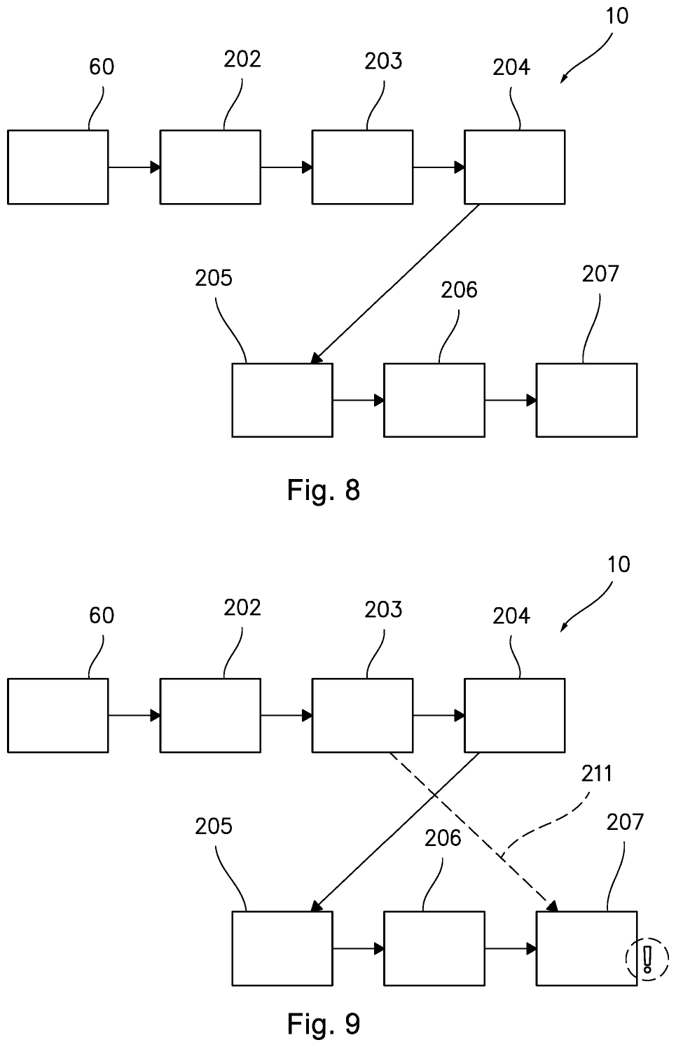

FIG. 8 shows a detail of an intralogistics system with a high storage rack, conveyors, dischargers and a stacking robot;

FIG. 9 shows the detail from FIG. 8 and an exemplary cause-of-fault relation between a discharger and the stacking robot;

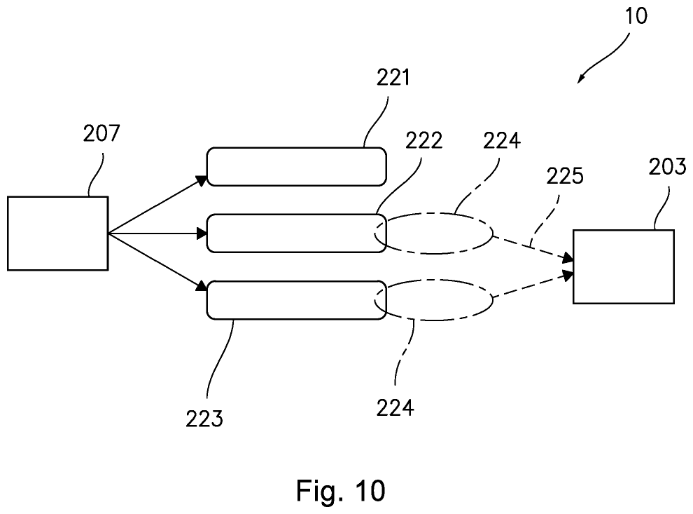

FIG. 10 shows exemplary pieces of information, parameters, normal and anomaly signal sequences on the stacking robot.

The figures are merely schematic and not to scale. Equal reference numbers in the different figures designate equal features, or features having the same effect.

### Embodiments

FIG. 1 shows an intralogistics system 10, which can be configured, for example, as a distribution center for different articles. The intralogistics system 10 shown comprises:
a rack system 18 for storing the articles,
workstations 26 for processing orders that were previously detected electronically,
a storage and/or retrieval system which connects the rack system 18 and the workstations 26 in terms of conveyor technology. The rack system 18 has a plurality of storage racks (components for storing articles) installed in a stationary manner.

The storage and/or retrieval system comprises one or multiple storage and retrieval units 20, as well as a mobile conveying system 22, for example AGVs and/or AMRs, and/or a stationary conveying system 24 (components for transporting articles) in order to store articles 14 in the storage racks or retrieve them from same, as well as in order to transport the articles 14 between the rack system 18 and the workstations 26.

In accordance with the example shown, the workstations 26 are configured for picking articles in accordance with the orders. To this end, articles 14 can be provisioned at a workstation 26 by means of the conveying system 22, 24 and loaded into target loading aids, in particular into a shipping package. Optionally, a goods receipt 12 is provided, where articles 14 (not shown in FIG. 1) are delivered with the help of delivery vehicles 16. These can be stored, for example, in the rack system 18.

Furthermore, the intralogistics system can have a goods issue 27. The readily picked and packaged articles 14 can be transported from the workstations 26 to the goods issue 27 with another (mobile and/or stationary) conveying system 22. There, they are received and transported away, once again by delivery vehicles 16.

As a rule, such intralogistics systems 10 are highly complex and have a plurality of most varied components. The interaction of all components is crucial for a high throughput and the demanded productivity. To this end, on the one hand, optimizations of components, resources and procedures are implemented already in the design phase of such an intralogistics system 10. Further, a complex sensor system 28 is provided during the productive operation of the intralogistics system 10 in order to synchronize settings and procedures in an optimal manner. The sensor system 28 generates information and data, which can be transmitted to a centralized control system, for example in the form of electric signals. In particular, the behavior of such signals over a specific period of time may often allow statements on operating mode, fault incidents, configurations and parameterization.

Examples of such signal sequences 30 are shown in FIG. 2 by way of example. The electric signal curves mapped on a timeline here can be, for example, discrete, defined conditions as represented in the first example. Here, the ordinate may represent current or voltage, for example, but also other physical quantities. Also analog curves, as represented in the second example, are possible. Also mixed forms are frequent, or also binary conditions, such as, for example, the triggering of a light barrier as shown in the third example. Signal sequences 30 can also be a compilation of multiple signal sequences 30. In accordance with one example, these multiple parallel signal sequences 30 relate to the same period of time. Signal sequences 30 are to be suited to describe properties, parameters and/or pieces of condition information of components of an intralogistics system 10 with the help of physical quantities, measurement values, data or otherwise suited pieces of information. The signal sequences 30 can describe, for example, a temperature curve of components of the intralogistics system 10, in particular during operation. The signal sequences 30 may also describe a picking performance, an order fulfillment rate or suchlike.

FIG. 3 shows an example of a method 100 for determining a cause of fault with the help of a graph model. To this end, reference anomaly signal sequences 32 are provisioned in a first step 110. These may be, for example, historic anomaly signal sequences, which can be verified in that they actually describe a fault condition or an irregular operating mode of a part and/or of a component of the intralogistics system 10. To this end, normal operation signal sequences 34 are known, which can describe a fault-free operating mode of the intralogistics system 10. The evaluation of deviations of the signal sequences 30 from these normal operation signal sequences 34 enables reference anomaly signal sequences 32 to be delimited and recognized. As a result, for example a plurality of stored reference anomaly signal sequences 32 from different periods of time and relating to different fault patterns can be stored.

Against the background that cause-effect relations in an intralogistics system 10 reveal themselves and become apparent in particular during fault incidents, also the reference anomaly signal sequences 32, therefore, include pieces of information on these cause-effect relations. In order to make these transparent, apparent and describable, a graph model 36 is computed, in a step 120, from these underlying reference anomaly signal sequences 32. The computation can be done, for example, with the help of suited algorithms and methods of analysis, such as, for example, graph algorithms, network analysis, graph analysis, machine learning, data mining and/or knowledge discovery in databases (KDD).

In accordance with one example, KDD is used to detect the pieces of information relating to the underlying reference anomaly signal sequences and to transfer them algorithmically to a graph model, which was first defined by a scheme. The graph model thus created is therefore used for structurally mapping cause-effect relations. In other words, machine methods of analysis are used to uncover functional or causal technical relations and interactions between different components and these multi-dimensional, network-like connections and dependencies are stored in a computer and/or in a suitable database in a format that can, in turn, be machine-processed.

The graph model 36, therefore, describes a technical interaction of the components of the intralogistics system 10 with the help of the properties, parameters and/or pieces of condition information of the components. In accordance with one example, the graph model 36 is updated with further new reference anomaly signal sequences 32. Optionally, the graph model 36 may also change because of a changed configuration of the intralogistics system 10, for example due to construction measures, maintenance and suchlike.

In a subsequent step 130, for the purpose of recognizing faults, an operative anomaly signal sequence 38 is provisioned relative to an associated normal operation signal sequence from signal sequences of a plurality of components of the intralogistics system. In other words, the operative anomaly signal sequence 38 represents, on the one hand, an anomaly condition, i.e. for example a faulty operating mode of the intralogistics system 10; on the other hand, the operative anomaly signal sequence 38 represents a signal sequence 30 from an operative operation of the intralogistics system 10 and is to describe a situation that has, in most cases, not yet been analyzed or evaluated. For example, the intralogistics system 10 reports a fault and the operative anomaly signal sequence 38 associated with this fault is generated.

This operative anomaly signal sequence 38 can describe, for example, a suitable period of time in which the fault condition occurred. For example, this may be a period of 30 minutes before the event up to the reporting of the fault. These slow changes, also referred to as drift, can be detected and evaluated over periods of time of suitable length. For example, if a bearing on a transport roll slowly heats up, a slow rise of the temperature of a sensor 28 in the associated signal sequence 30 will become apparent and can be recognized as a causal cause of fault in an analysis of the signal sequences 30.

In another step 140, the cause of fault associated with the operative anomaly signal sequence 38 of the intralogistics system 10, i.e. the piece of operative anomaly cause information 40, is derived and/or computed with the help of the now existing graph model 36, taking into account the knowledge of the known cause-effect relations. In other words, the graph model 36 of the intralogistics system 10, for example deposited in a graph database, now allows to analyze current fault conditions of a productive intralogistics system 10 and to ascertain the cause of fault. This considerably more effective method, allows, on the one hand, causes of fault to be determined faster and, on the other hand, measures for averting more serious faults or damage, or also measures such as preemptive maintenance, to be initiated in due time and also as a precaution.

FIG. 4 shows the general structure of a graph model 36 by way of example. A graph model consists of nodes 44, which may represent components of the intralogistics system 10, for example. Edges 46 interconnect nodes 44 and constitute, in this respect, an interactive relationship. Edges 46 can have a weighting 48, which may symbolize a strength of this interactive relationship. For example, if, due to a plurality of reference anomaly signal sequences 32, specific interactive relationships are often manifested, higher weightings 48 are anchored on the associated edges 46 in the model. Generally, the possibility to map, in terms of data technology, complex dependencies and structures can be regarded as an advantage of graph models 36.

The analysis of such graph models 36 for the purpose of determining causes of fault can be done by means of a graph analysis, for example. This may comprise a connectivity analysis, affiliation analysis and/or path analysis. Corresponding generic methods of analysis are known and described, for the most part, in the prior art.

FIG. 5 shows a storage region as a detail of an intralogistics system 10, which is to illustrate the relation between a diagnosed fault and the associated causes of fault. A palletizer 50 is arranged on a transport path 52, which is to describe a route of transport goods 14 through the storage region. Further, a buffer region 54, a sequencer 56 and a picking station 58 are provided. For the sake of completeness, also a high rack store 60 and a shuttle store 62 are specified, which are also located on the transport path 52. If the palletizer 50 reports a fault, a possible cause of fault may be within the palletizer 50 itself but also within the components with which this palletizer 50 interacts.

Generally, there are various possible reasons, such as, for example, mechatronic faults, problems in the flow of articles, operator's faults, wrong configuration of the palletizer or also so-called environmental faults, which are caused, for example, by detached films. In the example represented here, the diagnosed fault in the palletizer 50 may be attributable to faults in the buffer region 54, the sequencer 56 or also faults in the picking station 58. The faults there may already be causal, yet they may also, in turn, be effects of faults in upstream components.

FIG. 6 shows, in a schematic representation, a control unit 64 of an intralogistics system 10 for determining a cause of fault, i.e. a piece of operative anomaly cause information 40. First, an anomaly recognition unit 66 is provided, which is configured to recognize operative anomaly signal sequences 38 from signal sequences 30 of the intralogistics system 10. In other words, fault conditions are to be recognized here from the different signal sequences 30 of the system. Normal operation signal sequences 34, which are to describe a corresponding regular operation in relation to the signal sequences 30, serve as a reference for the recognition.

The evaluation of deviations, for example with the help of specific characteristic values or threshold values, enables operative anomaly signal sequences 38 to be determined and passed on. Optionally, an AI unit 70, for example, can be provided, which performs a classification of the operative anomaly signal sequences 38 with the help of an artificial neural network. Such an AI unit 70 may have hardware components and/or software components, for example, which are configured to carry out AI tasks, AI computations and/or AI analyses.

The determined operative anomaly signal sequences 38 can be stored in a reference anomaly database 72 so as to build a more comprehensive data basis for later evaluation. The operative anomaly signal sequences 38 determined in the first step and/or the reference anomaly signal sequences 32 stored in the reference anomaly database 72 are supplied to an analysis unit 68. This analysis unit 68 is configured to recognize cause-effect relations between the components of the intralogistics system from the reference anomaly signal sequences 32 that are made available from the reference anomaly database 72 and/or from the operative anomaly signal sequences 38 and to compute a graph model 36 therefrom. The graph model 36 can be stored, for example in the form of an adjacency matrix, adjacency list or incidence matrix of a graph data structure in a graph database 42.

In accordance with one example, the AI unit 70 can be provided or configured to determine a piece of operative anomaly cause information 40, i.e. a cause of fault for the operative anomaly signal sequence 38. This piece of operative anomaly cause information 40 is then provisioned to the analysis unit 68 as additional information for computing the graph model 36. Another possibility to provision a cause of fault, i.e. a piece of operative anomaly cause information 40, consists in a so-called tagging 74 by an operator 76 of the intralogistics system 10.

In this way, a diagnosed fault, i.e. an operative anomaly signal sequence 38, can be made available as information on an operating terminal 78 in suitable form. There, the operator 76 can input an associated cause of fault, i.e. a piece of operative anomaly cause information 40, based on his experience and his knowledge. Consequently, this piece of operative anomaly cause information 40 is assigned to the operative anomaly signal sequence 38 and therefore at least part of a functional cause-effect relation becomes apparent. Accordingly, this piece of operative anomaly cause information 40 generated by the operator 76 is made available to the analysis unit 68 for further evaluation.

In accordance with one example, the piece of operative anomaly cause information 40 is stored in the reference anomaly database 72 together with the associated operative anomaly signal sequence 38 as a reference anomaly signal sequence 32 with the associated piece of reference anomaly cause information 33. In other words, the reference anomaly database 72 thus comprises verified combinations of fault signal sequences and the associated causes of fault. The higher the number of these data pairs, the more accurately the analysis unit 68 can compute an associated graph model 36. The reference anomaly database 72, therefore, makes the reference anomaly signal sequences 32 with the associated pieces of reference anomaly cause information 33 available to the analysis unit 68 for evaluation.

Looking at the signal sequences 30 from the productive operation of the intralogistics system 10, the determined operative anomaly signal sequences 38 and optionally further the associated pieces of operative anomaly cause information 40, i.e. the associated causes of fault, are additionally made available to the analysis unit 68 for evaluation and computation of the graph model 36. Here, the piece of operative anomaly cause information 40 can be determined either via tagging 74 by the operator 76 or also via a machine evaluation with the help of an AI unit 70, for example. In accordance with one example, the AI unit is configured to determine a piece of reference anomaly cause information 33 from the plurality of the stored reference anomaly signal sequences 32.

While a focus of observation in FIG. 6 was the generation of the graph model 36 from the different input quantities and pieces of input information, FIG. 7 centers around the aspect of using the graph model 36 for determining a cause of fault in an intralogistics system 10. Shown here, too, is a control unit 64 of an intralogistics system 10 with an analysis unit 68 of a graph database 42. The analysis unit 68 is configured, on the basis of the operative anomaly signal sequence 38 made available in a precursory step, to compute an associated piece of operative anomaly cause information 40, i.e. a probable cause of fault, on the basis of the interactive relationships between the components of the intralogistics system 10 deposited in the graph model 36.

In the example represented here in FIG. 7, the operator 76 is made available multiple possible causes of fault, i.e. pieces of operative anomaly cause information 40, respectively weighted with a probability specification, on an operator terminal 78. These may serve, for example, as a template for decisions, which the operator will then supplement with his own expertise and experience and then select a, from his point of view most probable, cause of fault from the proposed pieces of operative anomaly cause information 40. In other words, the analysis unit 68 serves as a system for preparing a decision by the operator 76 here. The most probable cause of fault, i.e. piece of operative anomaly cause information 40, which is then finally selected by the operator 76, can then be stored as a reference anomaly signal sequence 32 together with the associated piece of reference anomaly cause information 33 in a reference anomaly database 72 (see FIG. 6) for later use.

Looking further at FIG. 7, a configuration unit 80 is provided. This is configured to generate and/or compute a configuration 82 of the intralogistics system 10. This may be, for example, part of an existing provisioning system for an intralogistics system 10, which is used in the planning phase. A configuration 82 of the intralogistics system 10 includes, for example, the parts lists, parameterization and other essential details relating to the structure and to the configuration of the intralogistics system 10. In the planning phase, due to the complexity of such intralogistics systems 10, a limited set of pieces of initial information and variables is used in order to first define the essential parameters of an intralogistics system 10 on the basis of the customer requirements. Often, cause-effect relations become apparent only in the real intralogistics system 10, so it would be desirable to render these additional pieces of information usable in an optimized configuration 82 of the intralogistics system 10.

Therefore, the configuration unit 80 is configured to compute an optimized configuration 82 of the intralogistics system 10 on the basis of the graph model 36, wherein the actual cause-effect relations from the real intralogistics system can advantageously be taken into account. In accordance with one example, the computation or generation of the optimized configuration 82 is done such that the occurrence of operative anomaly signal sequences 38, i.e. the occurrence of fault conditions, is minimized. In other words, knowledge of the cause-effect relations in the graph model 36 is to ensure that an initially created configuration 82 of the intralogistics system 10 can be optimized, so that considerably fewer cases of fault or failure occur. In more general terms, the configuration unit 80 is configured to compute an optimized configuration 82 of the intralogistics system 10 on the basis of a specified target quantity 84. Such target quantities may be, for example, an occurrence of specific anomalies, reduction of probabilities of fault, a reduction of energy consumption, a shortening of processing times, a reduced wear of the intralogistics system 10 or similar operative quantities.

For the above-mentioned relations of the subject matter in accordance with the invention, the procedures are also represented in relation to FIGS. 8 to 10 as additional explanations.

FIG. 8 shows a detail from an intralogistics system 10 with a high rack store 60 and/or a rack system, a stationary transport system 24 (not marked) comprising conveyors 202, 204 and 206, dischargers 203 and 205 and a stacking robot 207. This is to illustrate that articles, for example boxes and/or containers, are retrieved from the high rack store 60 by arriving at the stacking robot 207 via different conveying paths and dischargers (for example conveyor 202—discharger 203—conveyor 204—discharger 205 and conveyor 206). Here, the components of the intralogistics system 10 comprise both elements that are shaped by hardware and elements that are shaped by mechatronics, software or by a combination thereof. The connections in FIG. 8 symbolize the static relations of the components, for example the material flow.

It can be regarded as an anomaly, as it will be explained by way of example below, that a stack of articles is wavering or askew. Here, the signal sequences 30 and the normal operation signal sequences 34 of the component stacking robot 207 are defined as follows: The normal operation signal sequences 34 describe the pattern of a fault-free functioning of the stacking robot 207. The fault-free functioning is indicated by the following normal operation signal sequences 34, for example:

The wavering and/or inclination of a stack of the articles stacked by the stacking robot 207 are not too severe, i.e. within previously defined limit values. Here, the current value of a wavering and/or inclination may be detected by means of a light grille or by means of image recognition, for example. Independent of which method is used to recognize the condition and/or to detect the values, this results in one or multiple signal sequences 30, from which a condition of a correct stacking can be derived. This may be possible, for example by a change in the inclination over a period of time, in that a temporary inclination indicates a wavering, and a persisting inclination indicates a stack that is askew.

Other possible signal sequences 30 are, for example, a performance of the stacking robot 207. If the signal sequence 30, and therefore the performance of the stacking robot 207, is within specified limit values, i.e. a time series of stacking operations per minute or pallets per hour, for example, this can be regarded as a normal operation sequence 34. Other methods for determining a performance are also conceivable.

Other possible signal sequences 30 relate, for example, to an operating mode of the stacking robot 207 and may specify that the stacking robot 207 is in an operating mode which indicates that the stacking robot 207 is in operation, i.e. that it palletizes continuously. Other operating modes may be, for example: pausing, waiting for replenishment, wrong sequence, etc. The signal sequences 30 and/or normal operation signal sequences 34 consist of discrete stages, in this case. Usually, the stacking robot 207 is supplied with articles, wherein the articles are provisioned at the stacking robot 207 in a previously defined sequence, in particular optimized for stacking. The stacking robot 207 can continuously stack and/or palletize the articles. This corresponds to a normal operation sequence 34, for example. However, if the articles are provisioned at the stacking robot 207 in a sequence which deviates from the previously defined sequence, this corresponds to the operating mode “wrong sequence.” This may therefore be a signal sequence 30 which deviates from the normal operation sequence 34.

Other possible signal sequences 30 are, for example, a weight of the loads, i.e. the article(s), that are currently to be processed. If same is within specified limit values, the signal sequence 30 corresponds to a normal operation sequence 34.

Other possible signal sequences 30 are, for example, the temperature of the motors of the stacking robot 207, which may also be within specified limit values in order to correspond to the normal operation sequence 34.

The normal operation signal sequences 34 constitute a baseline, i.e. a basic value in the normal condition, against which the signal sequences 30 can be matched in order to determine operative anomaly signal sequences 38. An operative anomaly signal sequence 38 is preferably present whenever the signal sequence 30 deviates from the normal operation signal sequence 34, in particular beyond a tolerance and/or above a limit value.

The normal operation signal sequences 34, i.e. the baseline, are created by recording several to many hundreds of hours or recording cycles of the operative operation, during which no disruptions/anomalies occur. An operator optionally confirms that the signal sequences 30 are normal operation signal sequences 34. This means that the workflow, i.e. the signal sequences 30, is assessed manually.

These normal operation signal sequences 34 are stored in a data construct, e.g. a normal sequence database 221, see FIG. 10, in order for them to be matched against other signal sequences 30 later in order to recognize any operative anomaly signal sequences 38.

Here, the term database may refer to common databases; however, it is also possible that the database is dispersed, i.e. for example formed by multiple databases, each of which respectively comprises a part of the pieces of information. For example, one part of the database may comprise the associated graphs and another part the signal sequences 30 with the detected measurement values.

The signal sequences 30, parameters, properties, pieces of condition information associated with the respective components of the intralogistics system 10 may indicate the following values, for example:
high rack store 60: stock level per article/type of article; filling level per article/type of article; retrieval speed; orders in reserve which will be retrieved “shortly;” pieces of condition information of the individual component, for example of the components for transporting articles, for example single-level storage and retrieval units (shuttles) and/or multi-level storage and retrieval units (stacker cranes).
conveyors 202, 204, 206: speed; electricity consumption; starting currents; performance; temperature; pieces of mechatronic condition information.
discharger 203, 205: speed; pieces of mechatronic condition information.

General information, i.e. possible for all components: pieces of item information (master data such as weight, dimensions etc.); type of packaging (type of box) used.

A reference anomaly signal sequence 32 describes an anomaly already known at a specific point in time. Reference anomaly signal sequences 32 may occur, for example, during the installation (set-up, ramp-up), during fundamental training (pre-teaching of the system, e.g. before delivery or by simulation runs) or during operation. During operation, reference anomaly signal sequences 32 occur when an anomaly is recognized and the associated signal sequence 30 is marked accordingly. The procedure and/or the signal sequence 30 is then stored as a reference anomaly signal sequence 32. Analogously to the normal sequence database 221, this can also take place in a data construct, which can be referred to as reference anomaly database. This entirety of reference anomaly signal sequences 32 are designated in FIG. 10 as 222. The reference anomaly database is also shown in FIG. 6 as 72.

During the set-up/ramp-up or during the pre-teaching of the system, reference anomaly signal sequences 32 may occur when, for example, fault situations are intentionally simulated and the pattern of signal sequences 30 that occurs in the process is stored in the reference anomaly database 222 (72 in FIG. 6 of the application). The reference anomaly signal sequences 32 deposited in the reference anomaly database 222 may comprise additional pieces of information, such as, for example, a categorization, a taxonomy, tagging, free-text comments etc.

One example of reference anomaly signal sequences 32 is an increased wavering and/or inclination of the stack. One cause for this may be, for example, that the stacking robot 207 was supplied with a deformed box. Another example of a cause is that the stacking robot 207 does not receive the articles in the required sequence (i.e. a specified palletizing sequence) and therefore changes to the condition “wrong sequence,” which may, in turn, correspond to a reference anomaly signal sequence 32.

The signal sequences 30 are then detected during operation and continuously examined using different pattern recognition methods and/or matched against the normal operation signal sequences 34. If a deviation of the signal sequences 30 from the normal operation signal sequences 34 is determined here, this may constitute operative anomaly signal sequences 38. Should the signal sequences 30 comprise discrete values here, e.g. a machine condition, or an operating mode, this matching is very simple to carry out and to be assessed in a binary manner, i.e. “match” or “no match.” Other signal sequences, e.g. the wavering and/or inclination of the stack, which manifest, for example, as sine curves, are matched by means of different signal pattern recognition methods. By way of example, the following at least partially known methods can be mentioned here: z-score analyses; correlations (e.g. according to Pearson); distance comparisons (e.g. the euclidean distance); support vector machines; auto-encoders; and many more.

Operative anomaly signal sequences 38 may occur in a short period of time, e.g. a wavering that is very severe over a short time, or build up over a longer time, i.e. consistently accumulate, which is also referred to as drift. The recognition of drifts is crucial for the predictive operation of a system. This enables, e.g., proactive interference and preventive maintenance.

The operative anomaly signal sequences 38 thus recognized can optionally be displayed to an operator, who can then optionally interfere and perform one or multiple of the following actions: confirm that the sequence is an anomaly; discard the notification; enrich with additional pieces of information, such as, e.g., category (tagging), taxonomy, free text (type of packaging, origin of articles, supplier, transport company, etc.).

A confirmed operative anomaly signal sequence 38 can then be changed into a reference anomaly signal sequence 32 in the reference anomaly database 222 and stored there.

Analogously to the normal sequence database 221 and reference anomaly database 222, this can also take place in a data construct, which can be referred to as operative anomaly database 223. This entirety of operative anomaly signal sequences 38 are designated in FIG. 10 as 223.

As described above, the signal sequences 32, 34 and 38 stored in the databases 221, 222 and 223 are used as a basis for computing graph models 36, which map the technical relations between the components of the system and the procedures.

In order to determine the cause-of-fault relation, the system continuously analyzes the condition of the graph model 36 in a number (several dozens to many thousands) of cycles. Therefore, not only the anomalies of the individual components are recognized (as described above), but patterns in partial quantities or in the entire graph are recognized.

Here, different methods can be used, for example statistical methods and models; knowledge discovery and data mining; stream analysis and stream mining; artificial intelligence systems, e.g. neural networks; clustering; or other methods of machine learning.

One exemplary embodiment of this can be seen in FIG. 9. FIG. 9 shows the detail from an intralogistics system 10 as shown in FIG. 8 and an exemplary cause-of-fault relation between a discharger and the stacking robot. Here, the dashed line between the discharger 203 and the stacking robot 207 symbolizes a dynamic weighted relation. The weighting may change due to faults or other incidents. Specified here is one example, wherein the relation may comprise a weighting 211 and optionally also other pieces of information.

In the example shown, the system has recognized the operative anomaly signal sequence 38 “stack wavering” 224 on the stacking robot 207. The system knows the static or material flow relations of the system, as already described in relation to FIG. 8. Therefore, the system can determine, for example, that, at the point in time of the operative anomaly signal sequence “stack wavering” 224, the speed at the discharger 203 is always higher than a specific value, for example value N, which is detected in m/s. The system may also determine conditions 225 at which the anomaly rarely, or never, occurs at low speeds. Alternatively or additionally, the system may determine, for example, that the anomaly only occurs in specific types of boxes or articles. Also conceivable is a combined condition 225, i.e. the anomaly occurs only in one type of box and at speeds above N.

The system can therefore recognize a dynamic relation (dashed edge 211, FIG. 9). With each cycle in which this relation reoccurs, the weighting of this edge 211 will increase. If the relation stops occurring for a while, the weighting will reduce with each cycle.

Similarly to the operative anomaly signal sequences 38 above, the cause-of-fault relations can optionally be displayed to an operator, who can then optionally interfere and perform one or multiple of the following actions: confirm that the sequence is an anomaly; discard the notification; enrich with additional pieces of information, such as, e.g., category (tagging), taxonomy, free text (type of packaging, origin of articles, supplier, transport company, etc.).

Further, also a cross-store swarm intelligence can be used. Here, swarm intelligence shall mean an intralogistics system 10 as previously described. Here, cross-store shall mean a system that pools and evaluates the pieces of information from multiple stores.

The advantage here is that multiple intralogistics systems 10 naturally also generate many more reference anomaly signal sequences 32, so that a pool of reference anomaly sequences 32 for the pre-teaching is enlarged, an accuracy and/or reliability of the forecast and/or anomaly recognition of a system and/or a determination of the piece of cause information is improved.

The reference anomaly signal sequences and cause-of-fault relations collected due to this plurality of stores can be stored centrally and cross-plant. The storage can be carried out in known variants: cloud storage, central storage, separate storage and joint evaluation. If the stored data are subject to a need for protection, known security measures can be implemented: protection by password, encryption, etc. In case the stored data must be verifiable and provable, storing can be done by means of distributed ledger technology.

In any case, a cross-store system, in addition to the cross-plant graph model, also has one or multiple cross-plant databases:

A reference anomaly database comprises reference anomaly signal sequences 32 that occur in one of the plants. These sequences can then be automatically recognized also by another plant. The system can automatically respond to this and/or inform an operator accordingly that a similar, same or identical wavering problem is already occurring in another plant. Also additional pieces of information such as date, time, cause of fault and other available data can be issued, as previously described.

A cause-of-fault database can store causes of fault that have occurred so far and/or the pieces of operative anomaly cause information 40 relating to the different anomalies.

A normal sequence database may comprise the normal operation signal sequences 34 of specific intralogistics components (which may be present as hardware, mechatronics, software, or also as a combination thereof).

An operative anomaly database comprises the operative anomaly signal sequences 38 and the references to the causes of fault, in particular the pieces of operative anomaly cause information 40.

Generally, the implementation variants executed previously in relation to the databases are also for the databases of the cross-store swarm intelligence systems.

This central swarm intelligence ensures that analyses using the methods described above can also be carried out at later points in time (i.e. not in real time) and further insight and answers to previously unasked questions can thus be received.

Finally, it should be noted that terms such as “having,” “comprising,” etc. do not exclude other elements or steps and terms such as “a” or “an” do not exclude plurality. It should further be noted that features or steps that have been described with reference to one of the above embodiments can also be used in combination with other features or steps of other embodiments described above. Reference numbers in the claims are to be regarded as non-limiting.

Table of reference numbers

| | |
|---|---|
| 10 | intralogistics system |
| 12 | goods receipt |
| 14 | transport goods |
| 16 | delivery vehicles |
| 18 | rack systems |
| 20 | storage and retrieval unit |
| 22 | mobile transport system |
| 24 | stationary transport system |
| 26 | workstation |
| 27 | goods issue |
| 28 | sensor system |
| 30 | signal sequences |
| 32 | reference anomaly signal sequences |
| 33 | piece of reference anomaly cause information |
| 34 | normal operation signal sequences |
| 36 | graph model |
| 38 | operative anomaly signal sequence |
| 40 | piece of operative anomaly cause information |
| 42 | graph database |
| 44 | nodes |
| 46 | edges |
| 48 | weighting |
| 50 | palletizer |
| 52 | transport path |
| 54 | buffer region |
| 56 | sequencer |
| 58 | picking station |
| 60 | high rack store |
| 62 | shuttle store |
| 64 | control unit of the intralogistics system |
| 66 | anomaly recognition unit |
| 68 | analysis unit |
| 70 | AI unit |
| 72 | reference anomaly database |
| 74 | tagging by the operator |
| 76 | operator |
| 78 | operator terminal |
| 80 | configuration unit |
| 82 | configuration of the intralogistics system |
| 84 | target quantity for configuration |
| 100 | method for determining a cause of fault |
| 110 | provisioning of reference anomaly signal sequences |
| 120 | computation of a graph model |
| 130 | provisioning of an operative anomaly signal sequence |
| 140 | computation of a piece of operative anomaly cause |
| | information |
| 202, 204, 206 | conveyor |
| 203, 205 | discharger |
| 207 | stacking robot |
| 211 | weighting |
| 221 | normal sequence database |
| 222 | reference anomaly database |
| 223 | operative anomaly database |
| 224 | operative anomaly signal sequence “stack wavering” |
| 225 | condition |

1. A computer-implemented method for determining a cause of fault in an intralogistics system, comprising the steps:
provisioning a plurality of reference anomaly signal sequences relative to respectively associated normal operation signal sequences from signal sequences of a plurality of components of the intralogistics system;
wherein the signal sequences describe properties, parameters, and/or pieces of condition information of the respective component; and
wherein the reference anomaly signal sequences comprise known anomaly signal sequences from the intralogistics system and/or from at least one other intralogistics system;
computing a graph model of the intralogistics system on the basis of the plurality of the provisioned reference anomaly signal sequences;
wherein the graph model describes a technical interaction of the components of the intralogistics system with the help of the properties, parameters and/or pieces of condition information;
provisioning an operative anomaly signal sequence relative to an associated normal operation signal sequence from signal sequences of a plurality of components of the intralogistics system; and
computing, on the basis of the computed graph model, a piece of operative anomaly cause information relating to the operative anomaly signal sequence of the intralogistics system.

2. The method according to claim 1, wherein a provisioning of a piece of reference anomaly cause information in relation to the reference anomaly signal sequences is done additionally and a computing of the graph model is done additionally on the basis of the piece of reference anomaly cause information.

3. The method according to claim 2, wherein the provisioning of the piece of reference anomaly cause information is done via a human-machine interface.

4. The method according to claim 1, wherein the computing of the graph model is done with the help of methods of graph analysis, machine learning, data mining, queuing theory and/or knowledge discovery in databases (KDD).

5. The method according to claim 4, wherein the graph analysis in the computation of the graph model comprises a connectivity analysis, affiliation analysis and/or path analysis.

6. The method according to claim 1, wherein the provisioning of the reference anomaly signal sequences or of the operative anomaly signal sequence comprises recognizing a reference anomaly signal sequence or the operative anomaly signal sequence from a signal sequence using AI-based and/or machine-learning-based pattern recognition.

7. The method according to claim 2, wherein the provisioning of the piece of reference anomaly cause information is done by an artificial neural network and/or a machine-learning unit and/or AI unit, which has been trained with validated combinations of anomaly signal sequences and associated pieces of anomaly cause information.

8. The method according to claim 2, wherein the provisioning of the piece of reference anomaly cause information is done by querying a reference anomaly database with validated combinations of anomaly signal sequences and associated pieces of anomaly cause information.

9. The method according to claim 2, wherein the step of provisioning the piece of reference anomaly cause information in relation to the reference anomaly signal sequences and/or the step of provisioning the piece of operative anomaly cause information in relation to the operative anomaly signal sequence comprises the step of computing a probability of the occurrence of a respective anomaly cause.

10. The method according to claim 1, wherein the graph model can be stored as an adjacency matrix, adjacency list or incidence matrix of a graph data structure.

11. The method according to claim 1, wherein a provisioning of a configuration of the intralogistics system is done additionally and the computing of the graph model is done additionally on the basis of the configuration of the intralogistics system.

12. The method according to claim 1, wherein the method further comprises a step of generating an optimized configuration of the intralogistics system and/or its components on the basis of the computed graph model of the intralogistics system.

13. The method according to claim 12, wherein the generation of the optimized configuration of the intralogistics system is done such that a probability of an occurrence of operative anomaly signal sequences is minimized.

14. The method according to claim 1, wherein the provisioning of the reference anomaly signal sequences is done such that the multiple reference anomaly signal sequences of one or multiple components at least partially relate to the same period of time.

15. A computer program for determining a cause of fault in an intralogistics system, which is configured to execute the steps of the method in accordance with claims 1 during execution by a processor.

16. A computer-readable medium, which is configured to store the computer program in accordance with claim 15.

17. An intralogistics system with a plurality of components, wherein the components comprise:
a component for storing articles,
a component for processing orders, and
a component for transporting articles between the component for storing articles and the component for processing orders,
characterized in that
the intralogistics system is configured to execute the method in accordance with claim 1.

18. A computer-implemented method for determining a cause of fault in an intralogistics system, comprising the steps:
providing a plurality of reference anomaly signal sequences relative to respectively associated normal operation signal sequences from signal sequences of a plurality of components of the intralogistics system;
computing a graph model of the intralogistics system on the basis of the plurality of the provided reference anomaly signal sequences;
providing an operative anomaly signal sequence relative to an associated normal operation signal sequence from signal sequences of a plurality of components of the intralogistics system; and
computing, on the basis of the computed graph model, a piece of operative anomaly cause information relating to the operative anomaly signal sequence of the intralogistics system.

19. The method as claimed in claim 18, further comprising an intralogistics system having:
a component for storing articles;
a component for processing orders; and
a component for transporting articles between the component for storing articles and the component for processing orders.

20. A method for determining a cause of fault in an intralogistics system, comprising the steps:
providing a plurality of reference anomaly signal sequences relative to respectively associated normal operation signal sequences from signal sequences of a plurality of components of the intralogistics system;
computing a graph model of the intralogistics system on the basis of the plurality of the provided reference anomaly signal sequences;
providing an operative anomaly signal sequence relative to an associated normal operation signal sequence from signal sequences of a plurality of components of the intralogistics system;
computing, on the basis of the computed graph model, a piece of operative anomaly cause information relating to the operative anomaly signal sequence of the intralogistics system; and
generating an optimized configuration of the intralogistics system based on the basis of a computed graph model of the intralogistics system.
